(19) United States
(12) Patent Application Publication
(10) Pub. No.: US 2009/0229717 A1
(43) Pub. Date: Sep. 17, 2009

(54) Apparatus and system and method of providing easy protection to patrons holding multi-use pagers and the placement of advertising media thereon

(76) Inventors: Thor Halseth, Agoura Hills, CA (US); Jack Osborne, Sea Isle City, NJ (US)

Correspondence Address: SANDRA LEE LIPKIN A LAW CORPORATION, P.O.Box 3518, VENTURA, CA, 93006, US

(21) Appl. No.: 12/075,479

(22) Filed: Mar. 11, 2008

(51) Int. Cl. B65D 65/02; G06Q 30/00

(52) U.S. Cl. 150/165; 705/14

(57) ABSTRACT

An apparatus that provides a system and method for hygienically housing patron pagers while the patron waits for service. The apparatus includes a hub that secures a volume of sleeves. The hub can be secured to any surface with an adhesive strip. A pager is placed inside of one of the volume of sleeves and the sleeve is then removed from the hub through a perforation. Once removed, the top of the sleeve is adhesively secured around the pager. The sleeve contains various locations for the placement thereon of advertising and marketing media. Once the wait is over, the pager is removed through the bottom of the sleeve, which is removed at a perforation and discarded. The patron then keeps the sleeve which contains the marketing and advertising media for future use.

### BACKGROUND OF THE INVENTION

1. Field of the Invention

The present invention relates generally to the field of advertising in combination with protective sleeves, and more particularly to a disposable sleeve that surrounds a remote pager of the type used in any setting wherein there is a wait and the waiting party is given a pager to alert them when their wait is over, the sleeve offering space for advertising and the ability for the patron to take home the sleeve if desired for later use as a coupon or other promotional item.

2. Background

Pagers are being used more and more to alert waiting parties when their wait for service is over. Some examples of settings where it is found that pagers are given to waiting parties include restaurants, hospitals, car rental places, car dealerships, pharmacies and the like.

During the time of waiting, these pagers are sitting in the hands of patrons who may wander around the establishment shopping, using the restroom or just sitting and waiting for service with the pager in hand. During this time, the patron, particularly the patron that is sitting and waiting for service, is a captive audience for any messages contained on the pager and the instant invention provides a means for a sponsor to advertise to the patron during the wait.

The instant invention offers the added advantage of providing a protective cover over the pager so that there is minimal cross-contamination of any germs on the hands of multiple parties touching the pager throughout a business day.

A protective pager sleeve that is designed to provide protection from the cross-contamination described above is the subject of U.S. patent application Ser. No. 11/980,219 by the instant inventor. The instant invention expands on this pager cover sleeve to include a an easy method of dispensing by the establishment and focuses the invention to the inclusion of advertising and other marketing on the sleeve, including the use of coupons for the patron to take after use.

### SUMMARY OF THE INVENTION

The preferred embodiment of the present invention teaches an apparatus for the storage of a plurality of pager sleeves comprising: a hub with a top side and a bottom side, the bottom side being adherable to a surface, and the hub securing therein a plurality of pager sleeves wherein each of the plurality of pager sleeves further comprises a back panel having an interior face, an exterior face, a top edge, a bottom edge and two side edges; a front panel having an interior face, an exterior face, a top edge, a bottom edge and two side edges, with the front panel being shorter in length than the back panel and being connected to the back panel through the two side edges and through the bottom edge thereby forming a sleeve with an interior space for placement therein of a pager wherein the top edge of the back panel is connected to a stem through a first perforation, the stem being secured in the hub; a second perforation on the front panel just above the bottom portion of the front panel; a third perforation on the back panel just above the bottom portion of the back panel and substantially parallel with the second perforation wherein the sleeve can be opened through the ripping of the second and third perforations; and an adhesive strip located across the top of the interior face of the back panel below the first perforation with a removable strip placed thereon prior to use.

The above embodiment can be further modified by defining that the pager sleeve includes a transparent window on the front panel.

The above embodiment can be further modified by defining that the pager sleeve is completely opaque.

The above embodiment can be further modified by defining that advertising and marketing media such as special offers, coupons, game tokens and the like can be placed on the exterior face of the back panel.

The above embodiment can be further modified by defining that advertising and marketing media such as special offers, coupons, game tokens and the like can be placed below the transparent window.

The above embodiment can be further modified by defining that advertising and marketing media such as special offers, coupons, game tokens and the like can be placed on said exterior surface of the front panel.

A second embodiment of the instant inventions teaches a method of providing improved hygiene and promotional opportunities for business establishments utilizing pagers comprising the steps of: the placement of a pager inside of a pager sleeve that is part of an apparatus containing a plurality of pager sleeves, the apparatus further comprising: a hub with a top side and a bottom side, the bottom side being adherable to a surface, the hub securing therein a plurality of pager sleeves wherein each of the plurality of pager sleeves further comprises a back panel having an interior face, an exterior face, a top edge, a bottom edge and two side edges; a front panel having an interior face, an exterior face, a top edge, a bottom edge and two side edges, the front panel being shorter in length than the back panel and being connected to the back panel through the two side edges and through the bottom edge thereby forming a sleeve with an interior space for placement therein of a pager wherein the top edge of the back panel is connected to a stem through a first perforation, the stem being secured in the hub; a second perforation on the front panel just above the bottom portion of the front panel; a third perforation on the back panel just above the bottom portion of the back panel and substantially parallel with the second perforation wherein the sleeve can be opened through the ripping of the second and third perforations; and an adhesive strip located across the top of the interior face of the back panel below the first perforation with a removable strip placed thereon prior to use; releasing the pager sleeve from the hub through the tearing of the sleeve at the first perforation; removing the removable strip from the adhesive strip located across the top of the interior face of the back panel; folding the top of the interior face of the back panel over the exterior face of the front panel and securing thereto with the adhesive strip; handing the sleeve with the pager secured inside to a patron; removing the pager from the sleeve when patron returns the pager through the tearing of the second and third perforations thereby freeing the pager from the interior space; and returning the pager to the establishment leaving the pager sleeve with the patron.

The above embodiment can be further modified by defining that the pager sleeve includes a transparent window on the front panel.

The above embodiment can be further modified by defining that the pager sleeve is completely opaque.

The above embodiment can be further modified by defining that advertising and marketing media such as special offers, coupons, game tokens and the like are pre-placed on the exterior face of the back panel.

The above embodiment can be further modified by defining that advertising and marketing media such as special offers, coupons, game tokens and the like are pre-placed below the transparent window.

The above embodiment can be further modified by defining that advertising and marketing media such as special offers, coupons, game tokens and the like are pre-placed on the exterior surface of the front panel.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a top perspective view of the apparatus of the invention.

FIG. 2 is a top perspective view of the apparatus of the invention with a pager inside of the sleeve and ready to be disengaged from the pack.

FIG. 3 is a top perspective view of the apparatus of the invention with a pager inside of the sleeve and with the sleeve disengaging from the pack.

FIG. 4 is a top perspective view of the apparatus of the invention with the cover of the adhesive strip at the top being removed.

FIG. 5 is a top perspective view of the apparatus of the invention with the adhesive strip enclosing the pager inside the sleeve.

FIG. 6 is a top perspective view of the invention with the bottom portion being removed to remove the pager from the sleeve after use.

FIG. 7 is a top view of the invention holding a square or round shaped pager.

FIG. 8 is a top view of the invention holding an elongated rectangular shaped pager.

FIG. 9 is a top view of the invention with an alternate viewing window leaving more room on the pager sleeve for advertising media.

### DETAILED DESCRIPTION OF A PREFERRED EMBODIMENT

Turning to the drawings, the preferred embodiment is illustrated and described by reference characters that denote similar elements throughout the several views of the instant invention.

The preferred embodiment of the invention is illustrated in the attached figures.

The instant invention is an apparatus and method of use thereof for the distribution of disposable pager sleeves that includes space for advertising, marketing and other value-added features, such as coupons and other promotions. The sleeve itself can be seen as a portable billboard that includes valuable space for a captive audience that is marketable to third parties or can be utilized by the establishment itself.

For the establishment itself, the system can be used to increase profits to the establishment by advertising higher margin menu and drink items than the customer would normally purchase. By including coupons, game tickets and other value-added items onto the pager sleeve, customers are incentivized to return to the establishment for repeat business to the establishment. Additionally, the protective aspects of the sleeve lead to a perception of higher cleanliness and concern for customers by the establishment.

Additionally, third parties that sell their items, or otherwise wish to reach customers at establishments that use pagers, can pay for advertising, promotions and marketing on the sleeves for the use by the establishments. In an instance such as this, the establishment need not pay for the sleeves, but can still offer the advantages of protection from cross-contamination. Since an establishment cannot control the sanitation of its customers, the use of protective pager sleeves can provide cleanliness that appeals to customers and can reduce liabilities if sickness occurs due to cross contamination that while out of the control of the establishment, can still lead to litigation costs.

It is a fact that an establishment cannot control where patrons have put their hands prior to entering the establishment. There is no requirement that hands be washed before holding a pager or after using a restroom. Furthermore, many parents give the pagers to occupy children while waiting and children carry many bugs due to exposure to many other children at school and the like. Since the protective pager sleeves are already sanitary, the condition of the pagers themselves need not be a concern.

In the case of restaurants, the average number of pagers is between 50 and 75. Often patrons leave the establishment without returning the pager. With the use of the instant invention, the protective pager sleeve with coupons and other incentives, the patron is more likely to remember to return the pager. Because the cost of replacement of pagers is so high, the use of the protective pager sleeves is another money-saving product for the establishment.

In a typical week, pagers are given out between 8 and 10 times, depending upon the season. This translates to between 500 and 750 protective pager sleeves that will be handed out. This is extremely valuable for advertising, marketing and promotional purposes. Third parties can leverage this captive waiting time to deliver its message about its products and services.

To third parties, their message is seen by a captive audience for up to an hour at a time. During this time, there is no deleting the message. The client holds on to the pager until their wait is over. During this time, the pager is viewed typically by more than just one party, and is in fact viewed by up to three consumers. This translates into a message being seen by between 1500 and 2250 people each week. Extrapolating out to one year and by number of restaurants in the United States, a third party advertising can potentially have his message seen by between 1.95 billion and 2.925 billion customers.

The way the product is used is that a plurality of pager sleeves are manufactured and stacked together into a single unit. At the top of the unit where the plurality of sleeves are releasably connected, there is a top side and a bottom side. The bottom side has an adhesive strip that is protected by a releasable strip. The releasable strip is removed so that the entire unit can be releasably attached to a surface such as a table or a podium.

When a client shows up and has to wait, the establishment employee, a hostess in a restaurant setting, simply takes the pager and slips into to the sleeve, which has an opening at the top. The sleeve is then detached from the unit. At the top of the sleeve is another releasable strip that can be removed that leaves an adhesive strip that folds over the top of the sleeve to secure the pager therein.

The sleeve itself has an open window so that any advertising media found on the pager itself can be seen through the window. However, this window can also be carry advertising if that is required. On the bottom of the front of the pager sleeve and the entire backside is available for the placement of advertising, coupons, game tokens and other incentives.

Once the patron is called, the pager is returned to the establishment. At the bottom of the pager sleeve is a removable portion that opens the sleeve so that the pager can be removed. While the patron has waited for service, he or she has read the advertising and promotional materials on the sleeve and can choose to take the sleeve home for later use.

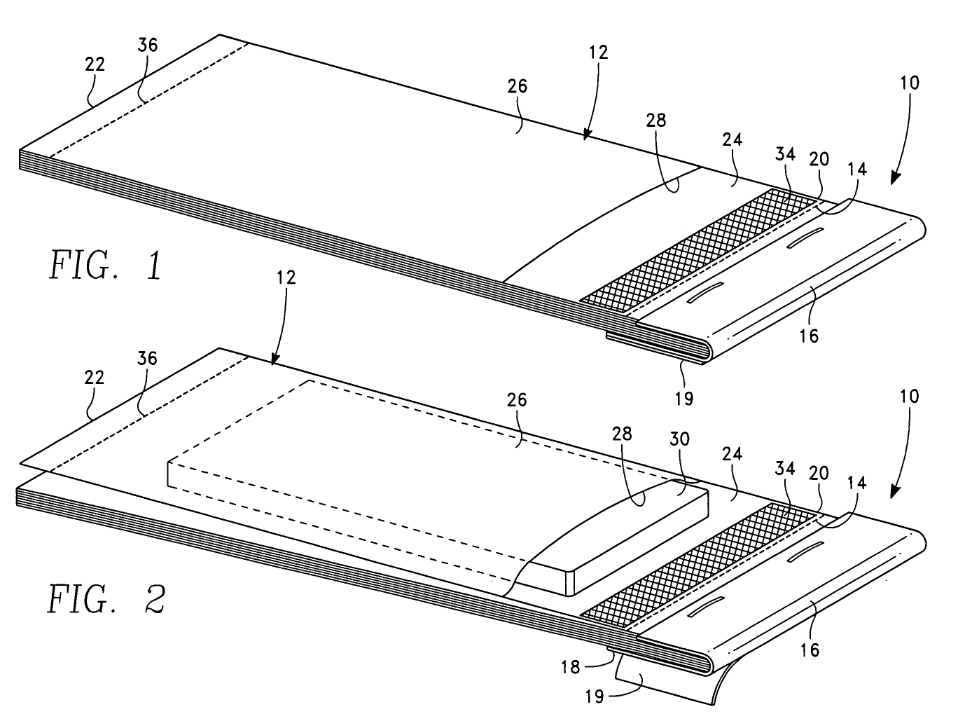

Particularly, FIGS. 1-6 show the method of the sequence. In FIG. 1, the apparatus 10 includes a plurality of pager sleeves 12 that are stacked on top of each other. Each of the plurality of pager sleeves 12 has a perforation 14 near the top of the sleeve where it is attached to a hub 16 that holds the plurality of sleeves 12 together. On the bottom of the hub 16 (best seen in FIG. 2) is an adhesive strip 18 that is covered by a removable strip 19. Once the removable strip 19 is removed, the hub 16 can be placed on any surface and secured thereon.

Each pager sleeve 12 has a top portion 20 and a bottom portion 22. Each pager sleeve includes a back panel 24 and a front panel 26 wherein the front panel 26 is slightly shorter in length than the back panel 24. As can easily be seen in FIG. 2, the front panel 26 lifts off from the back panel 24 leaving an interior space 28.

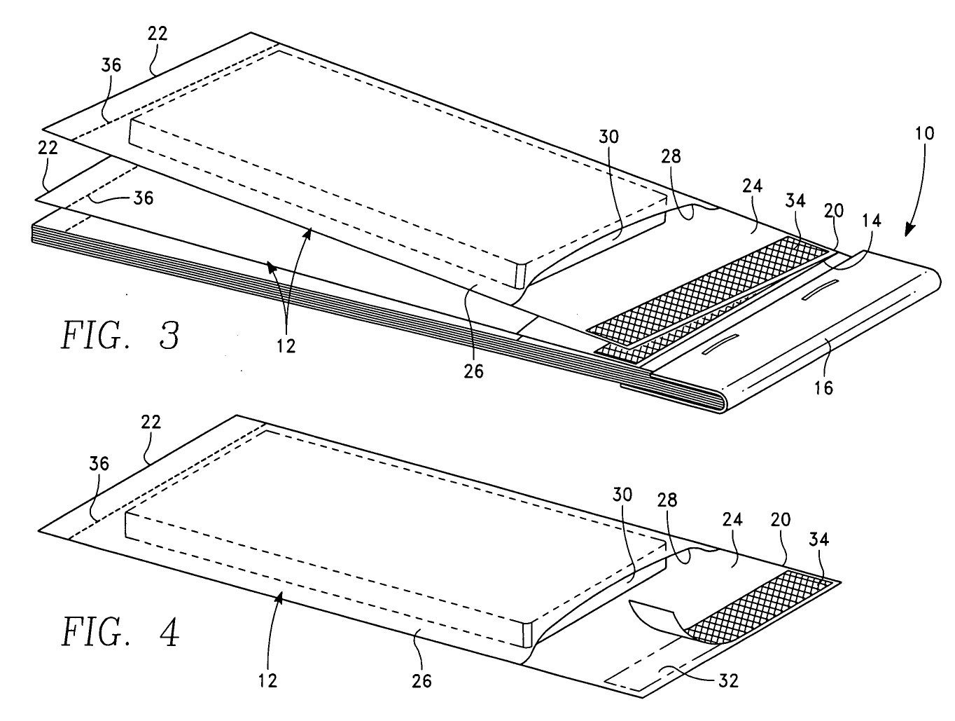

When a pager 30 needs to be handed to a patron, it is placed inside of the interior space 28. The individual sleeve 12 is then ripped at the perforation 14 near the top 20 of the sleeve 12 as is clear seen in FIG. 3. Near the top 20 of each sleeve 12, just below the perforation 14 is another adhesive strip 32 covered with a removable strip 34. As seen in FIG. 4, once the sleeve 12 has been removed at the perforation 14, the removable strip 34 is removed, exposing the adhesive strip 32.

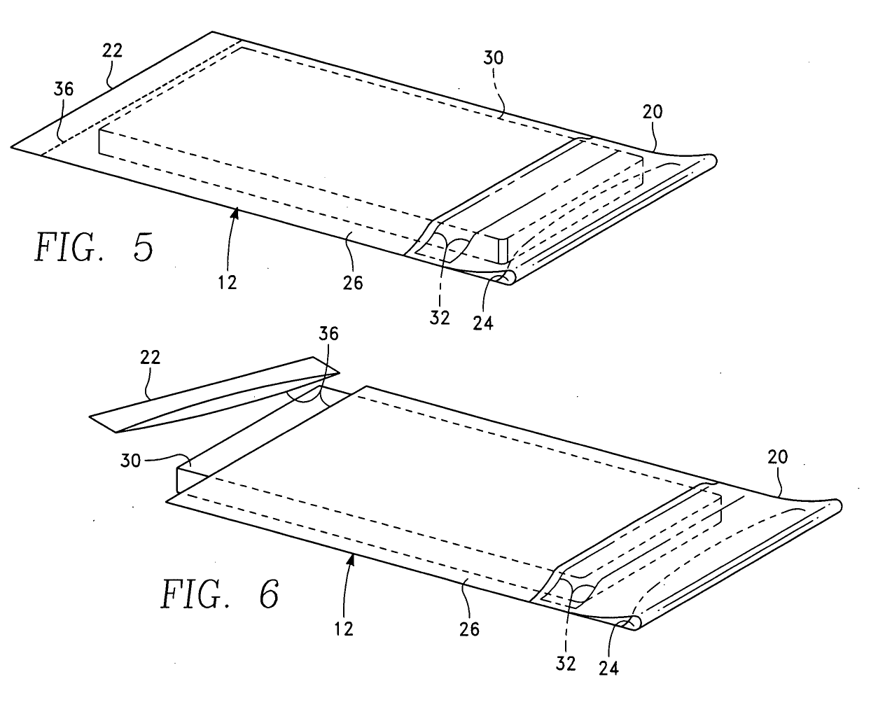

As seen in FIG. 5, the top 20 of the sleeve 12 is then folded over the front panel 26 and adhered thereto with the exposed adhesive strip 32. The patron then holds the pager 30 in the sleeve 12 until he is called. Once the patron is called, the pager 30 in the sleeve 12 is returned to the establishment personnel. The bottom portion 22 of the sleeve, which is also connected with a perforation 36, is then removed through the disengagement at the perforation 36. The pager 30 is returned from the sleeve 12 to the establishment and the rest of the sleeve 12, and associated advertising media found thereon, remains with the customer.

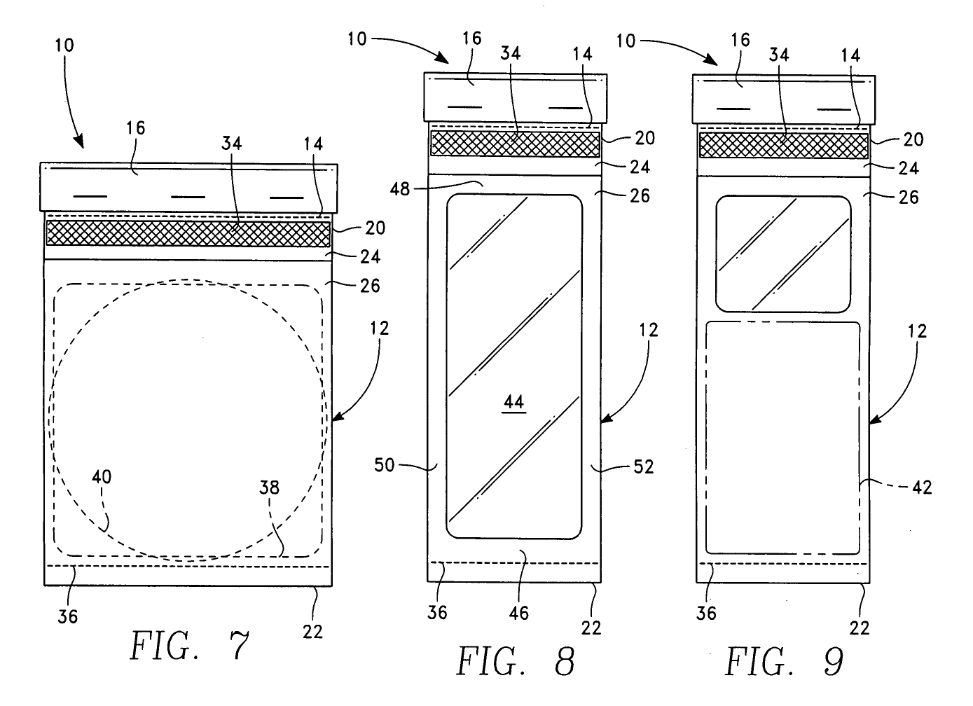

The locations for advertising media on the sleeve 12 itself are numerous. The entire back panel 24 is available. As seen in FIGS. 7-9, there is also space on the front panels 26. In FIG. 7 there are two phantom windows 38, 40. Depending upon the pager to be placed therein, either type of window, i.e., circular or square, can be used. The pager itself can contain advertising that shows through this window. As seen in FIG. 9, the pager can be mostly covered up (or entirely, but not shown here) leaving the lower panel 42 exposed for advertising.

FIG. 8 shows a long rectangular window 44 that exposes any media found on the pager placed therein. Space is available below 46, above, 48, the left 50, and to the right 52 of the pager window 44.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. An apparatus for the storage of a plurality of pager sleeves comprising:
a hub with a top side and a bottom side, said bottom side being adherable to a surface, said hub securing therein a plurality of pager sleeves wherein each of said plurality of pager sleeves further comprises
a back panel having an interior face, an exterior face, a top edge, a bottom edge and two side edges;
a front panel having an interior face, an exterior face, a top edge, a bottom edge and two side edges, said front panel being shorter in length than said back panel and being connected to said back panel through said two side edges and through said bottom edge thereby forming a sleeve with an interior space for placement therein of a pager wherein said top edge of said back panel is connected to a stem through a first perforation, said stem being secured in said hub;
a second perforation on said front panel just above said bottom portion of said front panel;
a third perforation on said back panel just above said bottom portion of said back panel and substantially parallel with said second perforation wherein said sleeve can be opened through the ripping of said second and third perforations;
and
an adhesive strip located across the top of said interior face of said back panel below said first perforation with a removable strip placed thereon prior to use.

2. The apparatus as defined in claim 1 wherein said pager sleeve includes a transparent window on said front panel.

3. The apparatus as defined in claim 1 wherein said pager sleeve is completely opaque.

4. The apparatus as defined in claim 1 wherein advertising and marketing media such as special offers, coupons, game tokens and the like can be placed on the exterior face of said back panel.

5. The apparatus as defined in claim 2 wherein advertising and marketing media such as special offers, coupons, game tokens and the like can be placed below said transparent window.

6. The apparatus as defined in claim 3 wherein advertising and marketing media such as special offers, coupons, game tokens and the like can be placed on said exterior surface of said front panel.

7. A method of providing improved hygiene and promotional opportunities for business establishments utilizing pagers comprising the steps of:
the placement of a pager inside of a pager sleeve that is part of an apparatus containing a plurality of pager sleeves, said apparatus further comprising:
a hub with a top side and a bottom side, said bottom side being adherable to a surface, said hub securing therein a plurality of pager sleeves wherein each of said plurality of pager sleeves further comprises
a back panel having an interior face, an exterior face, a top edge, a bottom edge and two side edges;
a front panel having an interior face, an exterior face, a top edge, a bottom edge and two side edges, said front panel being shorter in length than said back panel and being connected to said back panel through said two side edges and through said bottom edge thereby forming a sleeve with an interior space for placement therein of a pager wherein said top edge of said back panel is connected to a stem through a first perforation, said stem being secured in said hub;
a second perforation on said front panel just above said bottom portion of said front panel;
a third perforation on said back panel just above said bottom portion of said back panel and substantially parallel with said second perforation wherein said sleeve can be opened through the ripping of said second and third perforations;
and
an adhesive strip located across the top of said interior face of said back panel below said first perforation with a removable strip placed thereon prior to use;
releasing said pager sleeve from said hub through the tearing of said sleeve at said first perforation;
removing said removable strip from said adhesive strip located across the top of said interior face of said back panel;
folding said top of said interior face of said back panel over said exterior face of said front panel and securing thereto with said adhesive strip;
handing said sleeve with said pager secured inside to a patron;
removing said pager from said sleeve when patron returns said pager through the tearing of said second and third perforations thereby freeing said pager from said interior space; and
returning said pager to the establishment leaving said pager sleeve with said patron.

8. The method as defined in claim 7 wherein said pager sleeve includes a transparent window on said front panel.

9. The method as defined in claim 7 wherein said pager sleeve is completely opaque.

10. The method as defined in claim 7 wherein advertising and marketing media such as special offers, coupons, game tokens and the like are pre-placed on the exterior face of said back panel.

11. The method as defined in claim 8 wherein advertising and marketing media such as special offers, coupons, game tokens and the like are pre-placed below said transparent window.

12. The method as defined in claim 9 wherein advertising and marketing media such as special offers, coupons, game tokens and the like are pre-placed on said exterior surface of said front panel.
